(19) United States
(12) Patent Application Publication
(10) Pub. No.: US 2018/0308614 A1
(43) Pub. Date: Oct. 25, 2018

(54) Miniature remotely-controllable wide-range variable impedances for MRI and similar applications

(71) Applicant: Richard Cliff, Melbourne, FL (US)

(72) Inventor: Richard Cliff, Melbourne, FL (US)

(21) Appl. No.: 16/016,643

(22) Filed: Jun. 24, 2018

Related U.S. Application Data
(63) Continuation of application No. 13/905,198, filed on May 30, 2013, now abandoned.

(51) Int. Cl. H01F 21/12

(52) U.S. Cl. CPC H01F 21/12; H01G 5/0138; Y10T 74/1856

(57) ABSTRACT

Design and construction is described for remotely-controllable variable MRI-compatible low-noise inductors and capacitors, each having a wide variation range and each occupying a volume of no more than 30 cubic centimeters. To optimize noise figure in 3-tesla medical MRI antenna arrays, an exemplar capacitor is connected in series following an antenna element and an exemplar inductor is connected in shunt following an exemplar capacitor. Exemplar Inductors are constructed as a pair of flux-coupled coils which are connected by a movable or rotatable contactor positioned by folded and nested stepping mechanisms. Exemplar inductors are constructed from two flux-coupled parallel solenoid coils or from two flux-coupled toroid-segment coils. Exemplar capacitors are designed and constructed in an analogous manner. Other miniature inductor and capacitor embodiments are possible. Miniature variable resistor embodiments can be constructed in a manner analogous to that of the capacitors.

Application number tbd

Filed tbd 10

Prior publication data US 2014/0,354,389 A1 published Dec. 4, 2014

Related US application data application Ser. No. 13/905,198 filed May 30, 2013

Suggested US classifications subject to patent office direction

336/137 inductor devices/with means to change coil length or connections

361/300 electricity: electrical systems and devices/mechanically variable electrostatic capacitors with controlling or indicating means

### REFERENCES CITED US PATENT OFFICE DOCUMENTS

U.S. Pat. No. 7,663,367 B2 dated Feb. 16, 2010 titled Shaped MRI coil array by Wiggins, Graham C. Referenced as the Wiggins patent.
U.S. Pat. No. 8,299,681 B2 dated Dec. 19, 2017, U.S. Pat. No. 8,816,566 B2 dated Aug. 26, 2014 and
U.S. Pat. No. 9,847,471 B2 dated Oct. 30, 2012 titled Remotely adjustable reactive and resistive electrical elements and method by Snyder, Carl J., John Thomas Vaughan and Charles A. Lemaire. Referenced collectively as Snyder.
U.S. Pat. No. 8,922,212 B2 dated Dec. 30, 2014 titled Noise matching in couplet antenna arrays by Findeklee, Christian. Referenced as Findeklee.
U.S. Pat. No. 9,547,056 B2 dated Jan. 17, 2017 titled Dynamic modification of RF array coil/antenna impedance by Duensing, George Randall. Referenced as Duensing.
US 2014/0,354,389 A1 published Dec. 4, 2014 titled Compact step-programmable optimization of low-noise amplifier signal-to-noise by Cliff, Richard. Referenced as Cliff.

### REFERENCES CITED OTHER PUBLICATIONS

Wiggins, Graham C., J. R. Polimeni, A. Potthast, M. Schmitt, V. Alagappan and L. L. Wald, A 96-Channel Receive-Only Head Coil for 3 Tesla: Design, Optimization and Evaluation, Magnetic Resonance in Medicine, September 2009, volume 62, number 3, pages 754-762. Referenced as the Wiggins paper.
Zimmer, Carl, with photographs by Robert Clark, Secrets of the Brain, National Geographic Magazine, February 2014, volume 225, number 2, pages 28 through 57. Referenced as Zimmer.

Front page figure FIG. 5

### CROSS-REFERENCE TO RELATED APPLICATIONS

This application is a continuation of application Ser. No. 13/905,198 filed May 30, 2013 published as US 2014/0,354,389 A1 dated Dec. 4, 2014 titled Compact step-programmable optimization of low-noise amplifier signal-to-noise by Cliff, Richard. This continuation application is filed while the parent application is pending, is by the same inventor as the parent application and makes only claims that are completely supported by the parent application disclosures. This application has priority equal to the filing date of the parent application. Terms such as “at present” used in this application refer to the filing date of the parent application.

### STATEMENT REGARDING FEDERALLY SPONSORED RESEARCH OR DEVELOPMENT

Not applicable

### NAMES OF THE PARTIES TO A JOINT RESEARCH AGREEMENT

Not applicable

### REFERENCE TO A “SEQUENCE LISTING,” A TABLE OR A COMPUTER PROGRAM ON A COMPACT DISC

Not applicable

### BACKGROUND OF THE INVENTION

### Field of the Invention

This invention applies to areas of medical magnetic-resonance imaging systems, portable and miniature radio-frequency systems and radio-frequency component manufacturing, The species of this invention is miniature remotely-controllable variable impedances and impedance transformers. The exemplar embodiments are miniature low-noise remotely-controllable variable inductors and capacitors for use in medical magnetic-resonance imaging systems. Additional embodiments will be useful in other fields requiring remote control of compact including portable radio-frequency amplifiers, phased-array antennas and similar devices.

### Description of Related Art

This invention satisfies an unmet need in medical magnetic-resonance imaging technology. This need is referred to here as the ‘crowding problem’. This refers to a 128-megahertz active-antenna-array design used in brain-imaging research. This research antenna array is described by and pictured in the Wiggins paper. The photograph of the active antenna array in the Wiggins paper indicates the future evolution of at least research medical magnetic-resonance imaging systems and probably the future direction for clinical systems as well.

As indicated by the array in the Wiggins paper, development of high channel-count arrays is of great interest in the medical magnetic-resonance imaging field. But difficult problems are being encountered as the number of array channels goes higher. Another picture of a 96-element Wiggins-type active antenna array is shown on pages 30 and 31 of Zimmer. The Zimmer photograph is a recent and very clear display of the crowding problem. The problem is that high channel-count medical magnetic-resonance imaging antenna array performance is not always optimal because of component crowding and fixed impedance transformation between each antenna element and its immediately-following low-noise amplifier.

As is shown in the Zimmer photograph, each active array element consists of a small loop antenna, an immediately-following impedance transformer and in turn an immediately following low-noise amplifier. Because of first-stage noise figure dominance on the overall noise figure of a multi-stage signal-processing cascade, even a small noise figure deterioration in only a few of the 96 active elements can cause detectable degradation in the signal-to-noise ratio of the final image produced.

The signal-to-noise ratio of each channel in an array such as that shown in the Wiggins paper and in Zimmer can not at present be optimal at all times. This is because the needed optimal impedance transformation between each loop antenna and its following low-noise amplifier can change as different patients are imaged. Potentially, the performance of such high channel-count arrays can be improved by placing a small remotely-controllable low-noise variable impedance transformer between each loop-antenna array element and its following low-noise amplifier. Algorithms such as those described in Duensing and in Findeklee could then be employed under computer control to optimize image signal-to-noise ratio as might be required.

However, as is shown in the Zimmer photograph, the antenna array components and associated cabling are densely packed into a limited available volume. Any remotely-controllable impedance transformer which is too large to fit within the available space cannot be used. At present, no remotely-controllable impedance transformers operating at 128 megahertz are used in such arrays. Available components are either too large to fit into the very limited available volume of about 60 cubic centimeters per channel or do not provide the necessary large range of impedance variation or employ electronic adjustment and so are too noisy.

This invention is a family of four similar general designs for miniature variable impedances. The purpose of the invention exemplar embodiments is to solve the crowding problem. Because of the cascaded noise figure effect, an exemplar impedance transformer must especially have a noise figure which is as low as is feasible. And because of the very limited available space, an exemplar impedance transformer must especially occupy a volume of no more than 60 cubic centimeters. This is much smaller than any previously-realized impedance transformer having a wide impedance variation range at 128 megahertz.

Duensing and Findeklee call for employment of impedance transformers such as the exemplar embodiments of this invention. However, neither describes any hardware for implementation of their algorithms. Neither solves the crowding problem. The Wiggins paper presents no solution for the crowding problem. The Wiggins patent does not describe any solution for it either.

Remotely-controllable variable impedance concepts for use in magnetic-resonance imaging are described in Snyder. However, Snyder does not describe any means to realize impedance transformers which occupy a volume of no more than 60 cubic centimeters while providing an impedance-adjustment range as large as 30 to 80 nanohenry or 15 to 140 picofarad at 128 megahertz. None of Snyder's concepts provide means for implementation of algorithms such as those described in Duensing or in Findeklee in 3-tesla arrays, such as those shown in the Wiggins paper and in Zimmer.

But as is shown in in paragraphs [0036] through [0059] of Cliff and as is shown here, the purpose of the exemplar embodiments of this invention is to optimize signal-to-noise ratio in the same kinds of high channel-count, densely-populated antenna arrays as those shown in the Wiggins paper and in Zimmer. The species described in Cliff and here is not anticipated by Snyder's claims. Nor is it anticipated by any other patented art or public-domain art.

### Specific Embodiments

The embodiment attributes described here match the Findeklee and Duensing requirements for variable impedance transformers in arrays such as those shown in the Wiggins paper and in Zimmer. However, the exemplar embodiments described here are designed specifically to function correctly between a particular loop antenna element and a particular low-noise transistor having a particular bias network, as described in paragraphs [0036] through [0059] of Cliff and here. A different antenna element or a different low-noise amplifier transistor having a different bias network will in general require a different embodiment design.

Because of channel-to-channel coupling, even use in an array other than that which was used to develop an embodiment can require change to the embodiment design. However, the design process and structures described in Cliff and here may be used to create new embodiments of this invention when required.

### Embodiment Protection

The design methods and structures of the exemplar inductors and exemplar capacitors described here may be applied for other purposes. Other inductor embodiments can be realized using three or more solenoid coils or toroid coils or partial-toroid coils. Other capacitor embodiments can be realized using three or more linear capacitor stacks or circular capacitor stacks or partially-circular capacitor stacks. Such structures can be shorted by one or more than one movable or rotating contactors. Other stepping-structure embodiments are possible. Embodiments can be combined in networks other than series capacitance followed by shunt-inductance. Embodiments can combine one or more capacitors together with one or more inductors.

The operating frequency can be changed as can the size of the structures. Materials which do not satisfy magnetic-resonance imaging requirements can be used. Lossy materials may be employed rather than low-noise materials. The structures described here to realize exemplar miniature low-nose remotely-controlled variable capacitors can also be employed to realize miniature remotely-controlled variable resistors. The claimed design method and miniature structure approach are applicable over a wide range of variation. This disclosure protects all such other variable impedance embodiments as well as the exemplar embodiments described.

### BRIEF SUMMARY OF THE INVENTION

Embodiments of this invention are miniature variable impedance structures which have wide adjustment range, are suitable for remote control and are compatible with automated printed-circuit-board assembly. The exemplar embodiments are low-noise variable inductors and capacitors which operate at 128 megahertz. The exemplar inductors are constructed from two flux-coupled parallel solenoid coils or two flux-coupled partial-toroid coils. The exemplar capacitors are constructed from two parallel linear stacks of capacitors or two partially-circular stacks of capacitors.

The exemplar coils or exemplar capacitor stacks are electrically connected by a movable or a rotatable contactor. The exemplar contactors are moved or rotated by structures and actuators which are folded and nested to realize smaller size. The contactors are moved or rotated in single steps by means of ratchet mechanisms to realize smaller size and wide inductance or capacitance variation range.

An entire exemplar inductor occupies a volume of no more than 30 cubic centimeters and provides an inductance adjustment range of 30 to 80 nanohenry. An entire exemplar capacitor occupies a volume of no more than 30 cubic centimeters and provides a capacitance adjustment range of 15 to 140 picofarad. All exemplar embodiments are constructed in a manner and of materials which is compatible with medical magnetic-resonance imaging and with very low noise requirements. Many other embodiments of the invention besides the exemplars are possible.

### BRIEF DESCRIPTION OF THE DRAWINGS

FIG. 1 Two parallel solenoid coils which share magnetic flux.

FIG. 2 The parallel solenoid coils of FIG. 1 with terminals and a movable contactor.

FIG. 3 FIG. 2 with a package base including a rear side rail and a movable bi-directional folded rack for contactor positioning.

FIG. 4 FIG. 3 with a bi-directional folded rack-and-pawl single-stepping ratchet.

FIG. 5 FIG. 4 with nested actuators.

FIG. 6 FIG. 5 including a front side rail.

FIG. 7 FIG. 6 with a package side cover.

FIG. 8 FIG. 7 with a package lid.

FIG. 9 Two parallel capacitor stacks equivalent to the parallel solenoid coils of FIG. 1.

FIG. 10 The parallel capacitor stacks of FIG. 9 with terminals and a movable contactor.

FIG. 11 FIG. 10 with a package base including a rear side rail and a movable bi-directional folded rack for contactor positioning.

FIG. 12 Two partial-toroid coils which share magnetic flux.

FIG. 13 The partial-toroid coils of FIG. 12 with terminals and a rotatable contactor.

FIG. 14 FIG. 13 with a base including a rear side rail and a rotatable bi-directional folded rack for contactor positioning.

FIG. 15 FIG. 14 with a split folded rack-and-pawl ratchet.

FIG. 16 FIG. 15 with a nested actuator pair.

FIG. 17 Two partially-circular capacitor stacks replacing the partial-toroid coils of FIG. 12.

FIG. 18 The partially-circular capacitor stacks of FIG. 17 with terminals and a rotatable contactor.

FIG. 19 FIG. 18 with a base including a rear side rail and a rotatable bi-directional folded rack for contactor positioning.

### DETAILED DESCRIPTION OF THE INVENTION

### Invention Species

The species of this invention is miniature remotely-controllable variable impedances and impedance transformers. This invention is a family of four miniature remotely-controllable variable impedance structures, each having many embodiments, each corresponding to one of the four invention claims. Almost all of the mechanisms of the four embodiments are identical. They are all members of a single species.

### Exemplar Embodiment Requirements

The exemplar embodiments of this invention are low-noise remotely-controllable variable inductors and capacitors. The purpose of the exemplar embodiments of this invention is to optimize the signal-to-noise ratio of 3-tesla medical magnetic-resonance imaging antenna arrays. This purpose is accomplished by placing a series variable capacitor after each loop-antenna element in an array and by placing a shunt variable inductor after each series variable capacitor.

Each variable capacitor and its following variable inductor function together as a remotely-controllable impedance transformer at the input of each array low-noise amplifier. Each impedance transformer is individually adjusted by remote computer control to optimize the output signal-to-noise ratio of each low-noise amplifier in the array. The purpose of this invention imposes specific requirements on the exemplar embodiments. In turn, exemplar embodiment attributes have been developed to satisfy the imposed requirements.

Actuation requirements The exemplar embodiments must be compatible with miniature remotely-controllable actuators, such that an entire exemplar variable inductor or an entire exemplar variable capacitor embodiment occupies a volume of no more than 30 cubic centimeters, excluding control lines. The exemplar actuators and control lines must be as transparent as is feasible to the electromagnetic field to minimize image distortion and to so achieve better effective noise performance. Also, the actuators and control lines must satisfy magnetic-resonance imaging requirements.

Capacitance range requirement As described here and in paragraphs [0036] through [0059] of Cliff, the capacitor exemplar embodiments must provide minimum to maximum capacitance variation from from 15 picofarad to 140 picofarad in 5 steps.

Development design and testing requirements A development process must be defined and followed to determine the inductor and capacitor variation ranges that are needed and to decide the number of variation steps to be used.

Inductance range requirement As described here and in paragraphs [0036] through [0059] of Cliff, the inductor exemplar embodiments must provide minimum to maximum inductance variation from 30 nanohenry to 80 nanohenry in 5 steps.

Manufacturing tolerance requirements The variable inductor and capacitor exemplar embodiment designs must be tolerant of ordinary manufacturing variations of the exemplar antenna array elements, of the exemplar low-noise amplifiers and of the exemplar embodiments themselves.

Magnetic-resonance imaging compatibility requirement The variable inductor and capacitor exemplar embodiments must contain no ferromagnetic or other material producing a spurious magnetic-resonance response detectable by test in a medical magnetic-resonance imaging system. The presence of a material producing a spurious response is readily apparent in a dummy-load test image, also called a phantom test image. Qualification of materials by test is standard practice in the field.

Noise figure requirement Because of the cascaded noise figure effect, low exemplar noise is especially important. Each variable inductor and capacitor exemplar embodiment must have a noise figure of no more than 0.2 decibel. Such a small noise figure can not be directly measured. But it is standard practice in the field to take the noise figure of a linear passive device as being equal to its insertion loss.

Achieving the best possible exemplar noise figure must be considered in selection of materials and in structure design. Conductor and dielectric materials and capacitors must have the lowest feasible loss. Also, materials which are as transparent as feasible to the electromagnetic field must be used to minimize image distortion and so achieve better effective noise performance.

Operation requirements The variable inductor and variable capacitor exemplar embodiments must be functional at 128 megahertz, the operating frequency of 3-tesla medical magnetic-resonance imaging systems. The exemplar designs must be suitable for remote control. There are no exemplar reliability, operating lifetime or manufacturability requirements.

Package requirements The variable inductor and capacitor exemplar embodiments must be suitable for standard component packaging which can withstand automated assembly onto printed circuit boards.

Volume requirement Small exemplar size is particularly important. Each variable inductor and capacitor exemplar embodiment must occupy a volume of no more than 30 cubic centimeters for a total together of no more than 60 cubic centimeters.

Withstanding voltage requirement To be compatible with medical magnetic-resonance imaging use, the variable inductor and capacitor exemplar embodiments must withstand at least 500 volts without faulting.

### Exemplar Embodiment Attributes

The exemplars must be constructed in a specific manner to satisfy their requirements. Some attributes satisfy more than one requirement. Several requirements demand implementation of more than one attribute.

Actuation attributes To assist in satisfying the requirement that the exemplar inductors and capacitors each occupy a volume of no more than 30 cubic centimeters, each exemplar embodiment employs a nested remotely-controllable actuator or a nested remotely-controllable actuator pair. The actuators move or rotate the exemplar stepping structures to provide required inductance and capacitance variation.

Capacitor stack attributes To satisfy the requirement for exemplar embodiment volume of no more than 30 cubic centimeters, exemplar variable capacitors are formed as pairs of linear capacitor stacks or as pairs of partially-circular capacitor stacks, which are shorted by a movable or rotating contactor. Capacitor exemplars make use of structures which are, to the extent feasible, identical to corresponding inductor structures.

To satisfy the exemplar requirement for voltage withstanding, construction of the capacitor segments and the spacing or pitch of the capacitor segments are adjusted by design and test to withstand no less than 500 volts. To achieve the best possible noise figure and to meet the voltage withstanding requirement, the capacitor stacks are assembled from low-loss high-voltage capacitors, such as multi-layer ceramic chip types.

Development design and testing During the design process, exemplar embodiments are tested in a particular antenna array to evaluate and eventually realize the required ranges for inductance and capacitance variation and the number of steps of variation required. Dummy loads, also called phantoms are placed in the patient volume of the development array for these tests. Human volunteers can also serve. Five different volunteers or dummy loads are needed.

A center volunteer or dummy load is needed, who or which is matched as well as is feasible to the properties of the average patient intended to be imaged with the selected antenna array. As described here and in paragraphs [0036] through [0059] of Cliff, four additional volunteers or dummy loads are needed to determine the four corner values of inductance and capacitance variation needed to compensate for variation of array loading by patients and for variation of antenna and low-noise amplifier properties.

Other development design processes may be used to create embodiments of this invention. However, iterated design and measurement in an actual array with a range of volunteers or dummy loads, though time consuming, will in general yield the most satisfactory results. Design adjustment and test iteration can be continued until it is certain that the needed ranges for inductance and capacitance variation have been found. But available development time and resources may require compromise.

Flux sharing To satisfy exemplar requirements for component volume of no more than 30 cubic centimeters and a noise figure of no more than 0.2 decibel, the exemplar inductor pairs share flux. An inductor pair having a closed magnetic flux path is more compact than the same inductance with an open flux path. Flux sharing also provides better isolation from external signals, which effectively improves the noise figure of the inductor.

Inductor coil attributes To satisfy the exemplar requirements for component volume of no more than 30 cubic centimeters and noise figure no more than 0.2 decibel, the inductor exemplar embodiments are formed as pairs of flux-sharing parallel solenoid coils or pairs of flux-sharing partial-toroid coils. Each exemplar coil pair is shorted by a movable or rotating contactor. The movable or rotating contactor may contact the coil turns directly or may contact terminals which are placed along the turns of the coils. The diameter and length of the coil is adjusted by design and by iteration to realize the required inductance variation range.

To satisfy the exemplar voltage withstanding requirement, the diameter of the coil conductor and the spacing or pitch of the coil windings are adjusted by design and test to withstand no less than 500 volts. To achieve the best possible noise figure, the exemplar coils and contactor are composed of material having the highest feasible electrical conductivity. No particular coil or contactor material is required. But beryllium copper alloy will in general be preferred for better component service lifetime.

Mechanical structure attributes To satisfy the exemplar requirement for component volume of no more than 30 cubic centimeters, inductor exemplar embodiments employ bi-directional nested and folded linear or rotating rack-and-pawl ratchet single-step mechanisms. Actuation structures are moved or rotated by a remotely-controllable actuator or actuator pair.

In turn the actuation structures move or rotate the shorting contactors to provide inductance or capacitance variation within the required volume. Firm materials and securely-assembled structures are used to support consistent actuation. Capacitor exemplar embodiments employ actuation structures which are to the extent feasible identical to those of the inductors for economy and to assist in realizing the required component volume of no more than 30 cubic centimeters.

To satisfy the exemplar requirement for packaging which can withstand automated printed circuit board assembly, all materials and structures are compatible with pick-and-place stresses and tolerate automated soldering temperature. Also, exemplar mechanical structures are composed of strong and tough polymer or other materials, such as magnetically-inert delrin or teflon or ceramic. These are materials which are compatible with medical magnetic-resonance imaging requirements and are as transparent as feasible to the electromagnetic field to minimize image distortion and so achieve better effective noise performance.

Magnetic-resonance imaging compatibility To satisfy the exemplar requirement for magnetic-resonance imaging compatibility, all component materials are shown by imaging test to cause no spurious magnetic-resonance response.

Noise figure To satisfy the exemplar requirement for noise figure of no more than 0.2 decibel, conductors are composed of materials having electrical conductivity which is as high as is feasible. Stack capacitors are selected which have loss as low as is feasible. Also, use of conductive materials in the exemplar structures is reduced as much as is feasible to minimize magnetic-resonance image-distorting eddy currents. This reduces effective noise in images. To the extent feasible, the exemplars are constructed to be transparent to the electromagnetic field.

Package attributes To satisfy the exemplar requirement for standard component packaging which can withstand automated assembly of printed circuit boards, the exemplars are constructed on an insulating base compatible with through-hole or surface-mount printed circuit board installation. The insulating base is designed to accept a package cover having top and side walls. This cover may be a unit or may be composed of parts. Depending upon detailed considerations, the cover may be omitted.

The exemplar package base and cover are to the extent feasible composed of non-conductive material and are firmly assembled. When used, the exemplar cover is firmly attached to the package base by non-conductive means. Use of non-conductive material achieves better effective noise performance by helping to minimize image-distorting eddy currents. To the extent feasible, the exemplars are constructed to be transparent to the electromagnetic field.

Stepping structure attributes To satisfy the exemplar requirements for inductance variation from 30 nanohenry to 80 nanohenry and capacitance variation from from 15 picofarad to 140 picofarad within a volume of no more than 30 cubic centimeters, the exemplar embodiments employ stepping rather than continuous variation. In addition, stepping enables realization of predictable capacitance and inductance variability without employment of feedback control. Once a particular component has been characterized, it can be positioned by a remote control computer to values known in advance, within a tolerance.

Step-pitch matching Linear or rotating rack step-change spacing or pitch is matched to inductor or capacitor step-change spacing or pitch.

### Exemplar Embodiment Details

Development design and testing Depending on time and resources available, embodiment development can be more time consuming and more accurate or more approximate and abbreviated. Different embodiments developed for different purposes may require different development processes. For medical magnetic-resonance imaging use, optimal embodiments will eventually be determined by image evaluation for clinical or at least research usefulness. Such thorough evaluation will require an extended period. For first demonstration of exemplar embodiments, a shorter and more approximate process is used.

In order to realize the inductor and capacitor exemplar embodiments, a particular medical magnetic-resonance imaging receiving antenna array is selected. The antenna array includes a particular set of low-noise amplifiers. The selected array is populated with fixed-value series capacitors followed by fixed-value shunt inductors installed between each antenna element and its following low-noise amplifier. A center dummy load or center volunteer is placed in the patient volume of the development array. The signal-to-noise ratio of each channel and simultaneously the signal-to-noise ratio of the entire array is measured. Then fixed inductors and capacitors having adjusted values are installed and all signal-to-noise ratio measurements are performed again.

The cycle of adjusting inductor and capacitor values and of measuring all signal-to-noise ratios is repeated until finally the signal-to-noise ratio of each channel and simultaneously the signal-to-noise ratio of the entire array is improved to a selected level. Then one of the four corner volunteers or corner dummy loads is placed in the patient volume of the development array. And the cycle of adjusting the inductor and capacitor values and measuring the array and channel signal-to-noise ratios is repeated again. Until again the signal-to-noise ratio of each channel and simultaneously the signal-to-noise ratio of the entire array is improved to a selected level.

Then another of the four corner volunteers or corner dummy loads is placed in the patient volume of the development array and the process is repeated again. After the signal-to-noise ratio of each channel and simultaneously the signal-to-noise ratio of the entire array is improved to a selected level for all five dummy loads or volunteers, the four corners of needed inductor and capacitor variation have been determined, as shown in paragraphs [0036] through [0059] of Cliff. For first demonstration of the exemplar embodiments, an inductor range of 30 nanohenry to 80 nanohenry in 5 steps is selected and a capacitor variation range of from 15 picofarad to 140 picofarad in 5 steps is selected.

For tolerance allowance as required, the highest series capacitor value found by test plus 10 percent is taken as the upper end of the variable capacitance range. The lowest series capacitor value found minus 10 percent is taken as the lower end of the variable capacitance range. The highest shunt inductor value found plus 10 percent is taken as the upper end of the variable inductance range. And the lowest shunt inductor value found minus 10 percent is taken as the lower end of the variable inductance range. Other embodiments may require different tolerance allowances.

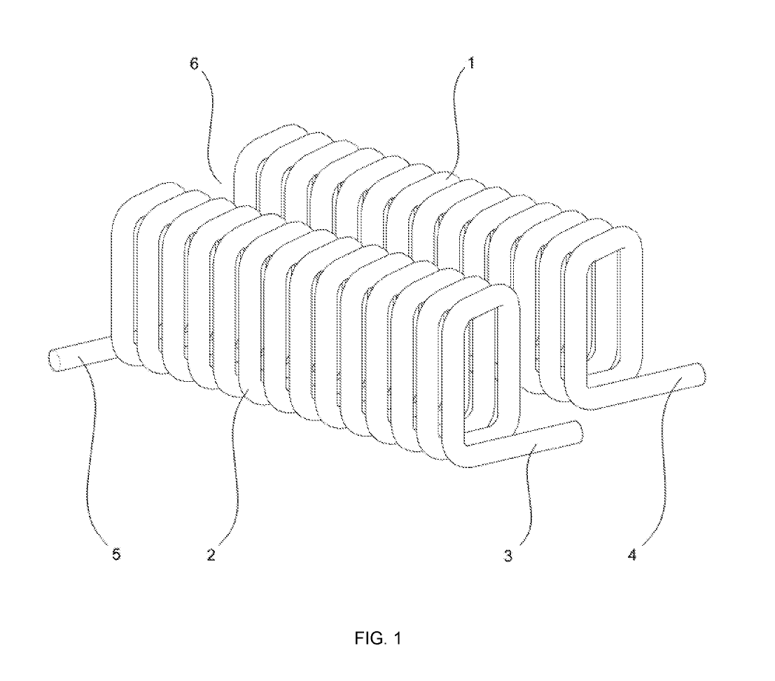

Exemplar linear inductor details The linear exemplar inductor embodiment is shown in FIGS. 1 through 8. FIG. 1 shows a parallel solenoid coil pair (1) and (2). Far coil (1) has near end (4) and far end (6). Far end (6) is hidden in this view. Near coil (2) has near end (3) and far end (5). The parallel solenoid coil pair (1) and (2) are wound on insulating cores. For better clarity the insulating cores are not shown in this view. The parallel solenoid coil pair (1) and (2) is shown configured to share magnetic flux. Flux sharing is obtained by arrangement of the parallel solenoid coil pair (1) and (2) for continuous right-hand current parity about a closed magnetic-field path (4) to (6) to (5) to (3) closed to (4).

Use of flux-sharing in the parallel solenoid coil pair (1) and (2) realizes a coil structure that is more compact than a single solenoid coil for production of a given inductance. This results in smaller overall component size. Also, as is the case for any closed path coil or coil pair, flux-sharing gives better isolation of the inductor from external signals, which are effectively interfering noise. This improves the effective noise performance of the inductor.

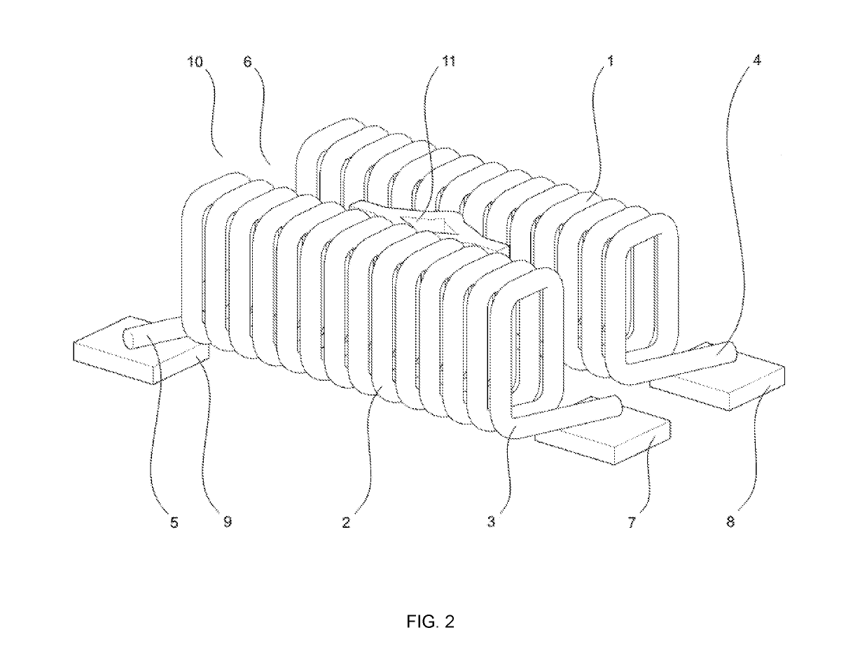

In FIG. 2 the parallel solenoid coil pair (1) and (2) is shown supported by mounting pads (7), (8), (9) and (10) for compatibility with a component package as required. Mounting pad (10) is hidden in this view. The parallel solenoid coil pair (1) and (2) are wound on insulating cores. For better clarity the insulating cores are not shown in this view. Mounting pads (7) and (8) function as the inductor terminals (7) and (8). Mounting pads (9) and (10) provide electrically-isolated mechanical support. Depending upon detailed considerations, mounting pads (9) and (10) may be omitted.

A movable contactor (11) which provides electrical connection between the parallel solenoids (1) and (2) is also shown. As the position of the movable contactor (11) is changed, the inductance which appears at the inductor terminals (7) and (8) changes in steps over the required inductance range.

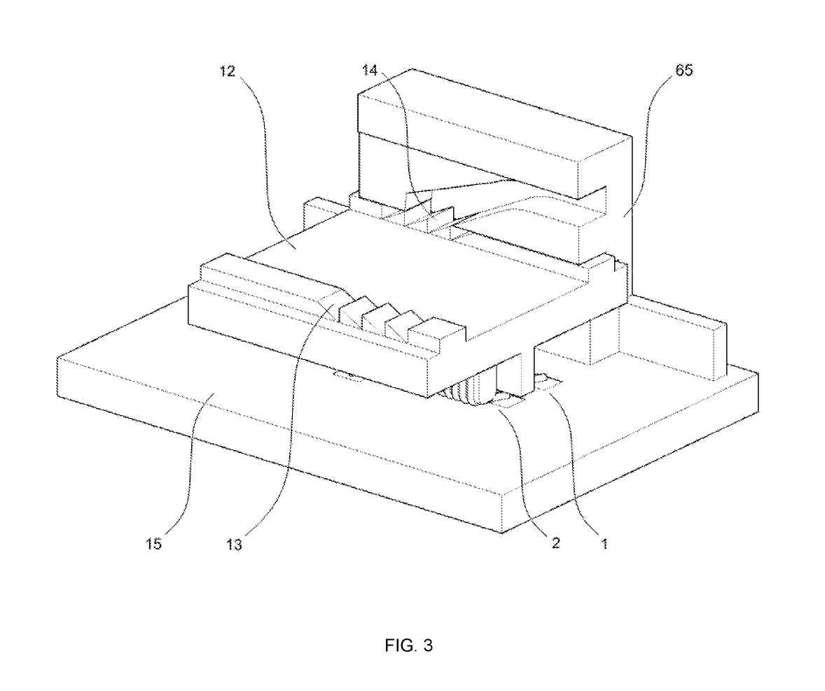

In FIG. 3, a movable bi-directional folded rack (12) is shown attached to the movable contactor (11). The movable contactor (11) is hidden in this view. The movable bi-directional folded rack (12) positions the movable contactor (11). The movable bi-directional folded rack (12) is supported by a firm rear package side rail (65) which is supported by a firm component package base (15).

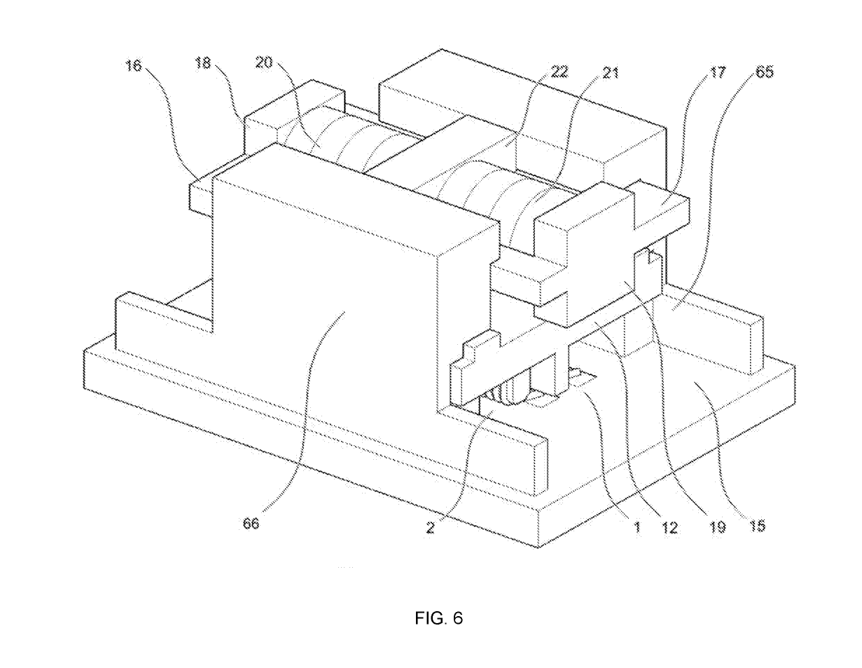

The movable bi-directional folded rack (12) is also supported by a firm front side rail which for better clarity is not shown in this view. The front side rail (66) is shown in FIG. 6. It is identical to the rear side rail (65) but is installed rotated 180 degrees about a vertical axis. The movable bi-directional folded rack (12) is positioned by opposing rack teeth (13) and (14) which permit either increasing or decreasing in single steps the inductance which appears at the inductor terminals (7) and (8) in FIG. 2.

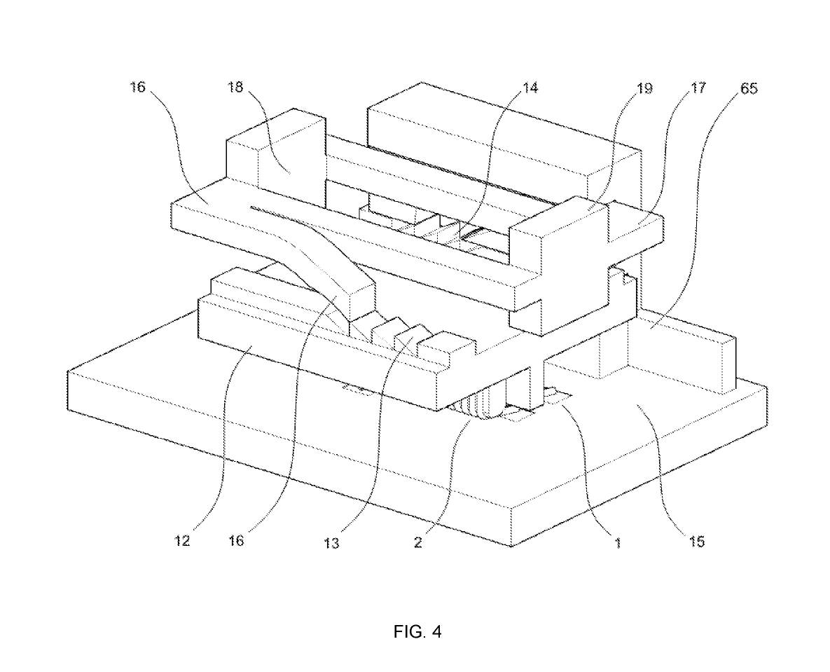

In FIG. 4 the parallel solenoid coil pair (1) and (2) and the movable bi-directional folded rack (12) are shown in place beneath a movable bi-directional single-stepping folded pawl pair (16) and (17). The rear pawl (17) is partly hidden in this view. It faces in the opposite direction from that of the front pawl (16) so that the pawls (16) and (17) throw alternately in opposite directions. The pawls (16) and (17) are stiff but have some flexibility in the vertical direction. This allows the pawls (16) and (17) to engage the rack teeth (13) and (14) and to move the folded rack (12) one tooth length at a time. Nested within the movable bi-directional folded pawl pair (16) and (17) is an actuator frame (18) to (19).

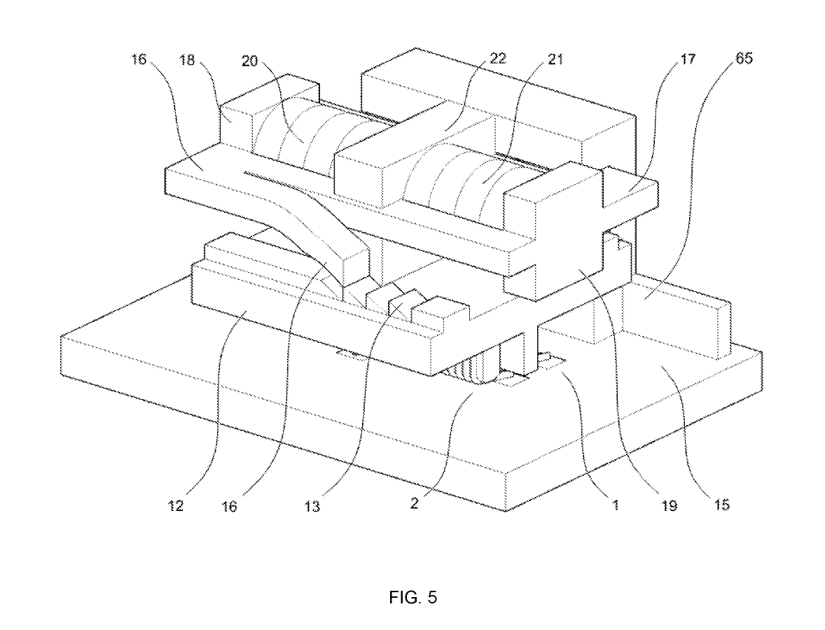

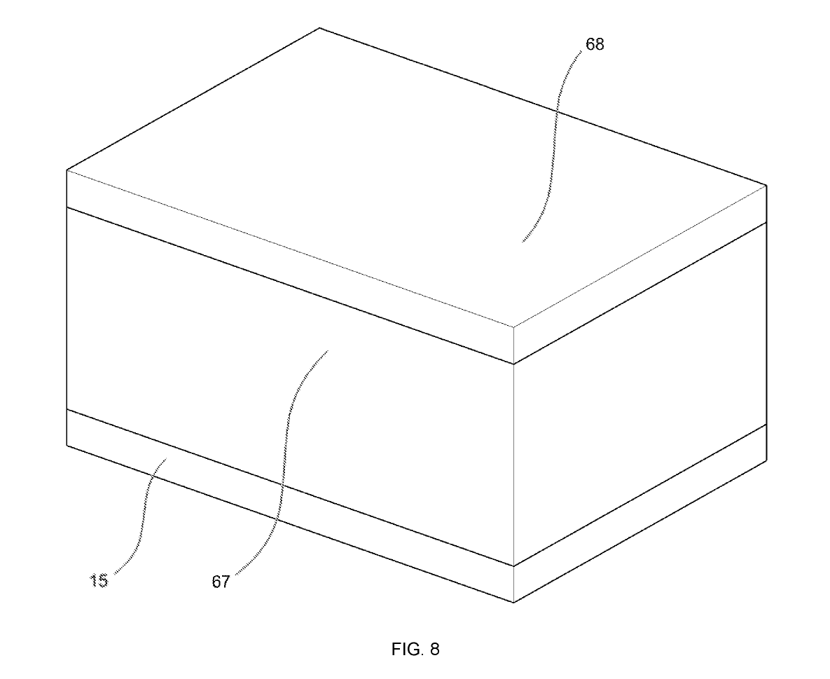

In FIG. 5 a bi-directional actuator (20), (21) and (22) is shown nested within the actuator frame (18) to (19). The nested bi-directional actuator (20), (21) and (22) permits remotely-controllable positioning of the movable bi-directional folded pawl pair (16) and (17). The actuator (20), (21) and (22) has a firm center block (22) which does not move and provides support for the expandable and contractible actuators (20) and (21). The actuator block (22) is firmly supported by the rear side rail (65) and the front side rail (66) in FIG. 6. Additional firm support for the actuator block (22) is available from a firm package lid (68) in FIG. 8. For better clarity, connection of control lines to the actuator is not shown.

In FIG. 6 the front package side rail (66) is shown in position on the package base (15). The front and rear side rails (66) and (65) provide firm support for all the mechanical structures.

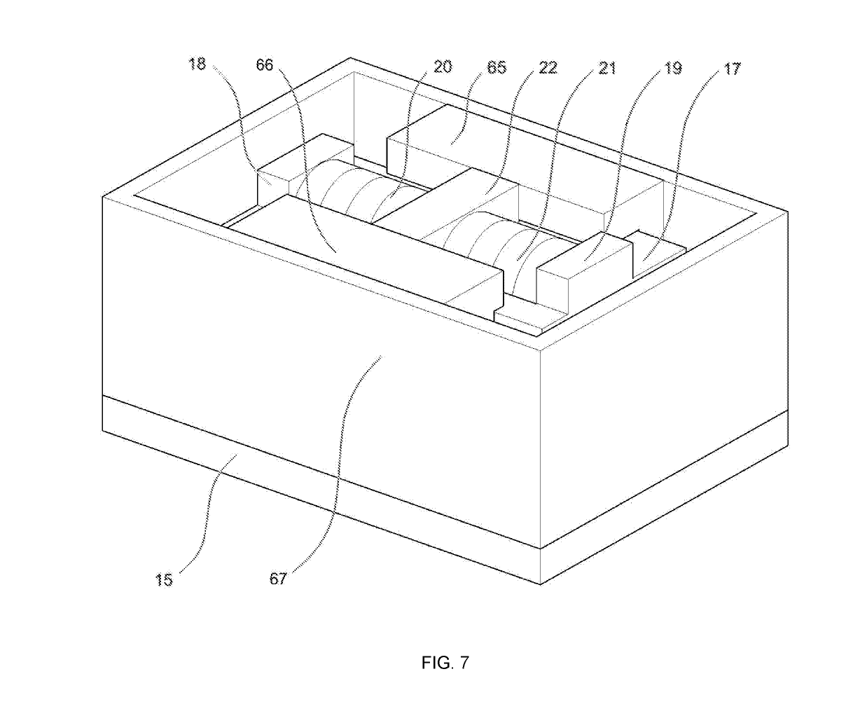

In FIG. 7 a firm package enclosure (67) is shown in place on the package base (15). The package enclosure (67) provides additional firm support for all the mechanical structures. And it also provides protection for the mechanical structures from contamination. Depending upon detailed considerations, the cover may be omitted.

In FIG. 8 a firm package lid (68) is shown in place on the package enclosure (67). For better clarity, connection of control lines to the package is not shown. The package lid (68) provides additional firm support for all the mechanical structures. And it also provides protection for the mechanical structures from contamination. Depending upon detailed considerations, the lid may be omitted.

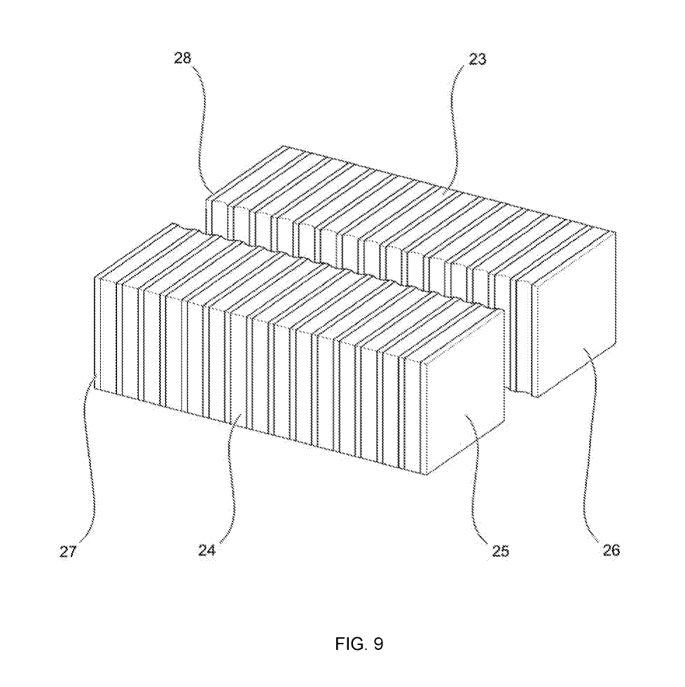

Exemplar linear capacitor details The linear capacitor exemplar embodiment is shown In FIGS. 9 through 11. This capacitor exemplar is analogous to the inductor exemplar shown in FIGS. 1 through 8. To the extent feasible, it uses the same construction as the linear inductor exemplar.

FIG. 9 shows a pair of parallel capacitor stacks (23) and (24) which are analogous to the parallel solenoid coil pair (1) and (2) in FIG. 1. Far stack (23) has near end (26) and far end (28). Near stack (24) has near end (25) and far end (27).

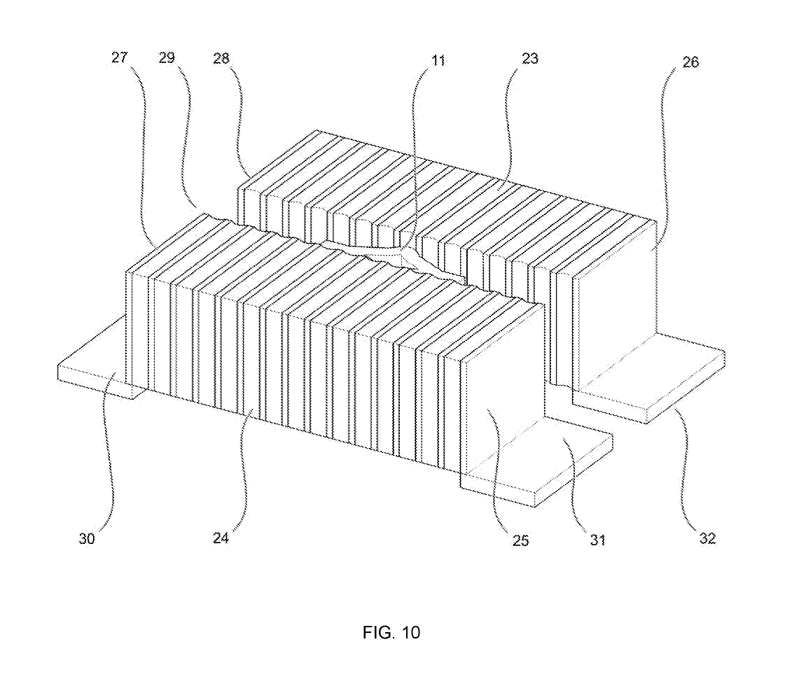

FIG. 10 shows the parallel capacitor stacks (23) and (24) supported by mounting pads (29), (30), (31) and (32), which are analogous to the parallel solenoid coil pair (1) and (2) mounting pads (7), (8), (9) and (10) in FIG. 2. Mounting pad (29) is hidden in this view. Mounting pads (29) (30) (31) and (32) are compatible with a standard component package (15) in FIGS. 3, 4, 5, 6, 7 and 8 as required.

Mounting pads (31) and (32) function as the capacitor terminals (31) and (32). Mounting pads (29) and (30) provide electrically-isolated mechanical support. Depending upon detailed considerations, mounting pads (29) and (30) may be omitted. A movable contactor (11) which provides electrical connection between the parallel capacitor stacks (23) and (24) is also shown in analogy with FIG. 2. As the position of the movable contactor (11) is changed, the capacitance which appears at the capacitor terminals (31) and (32) changes in steps over the required capacitance range.

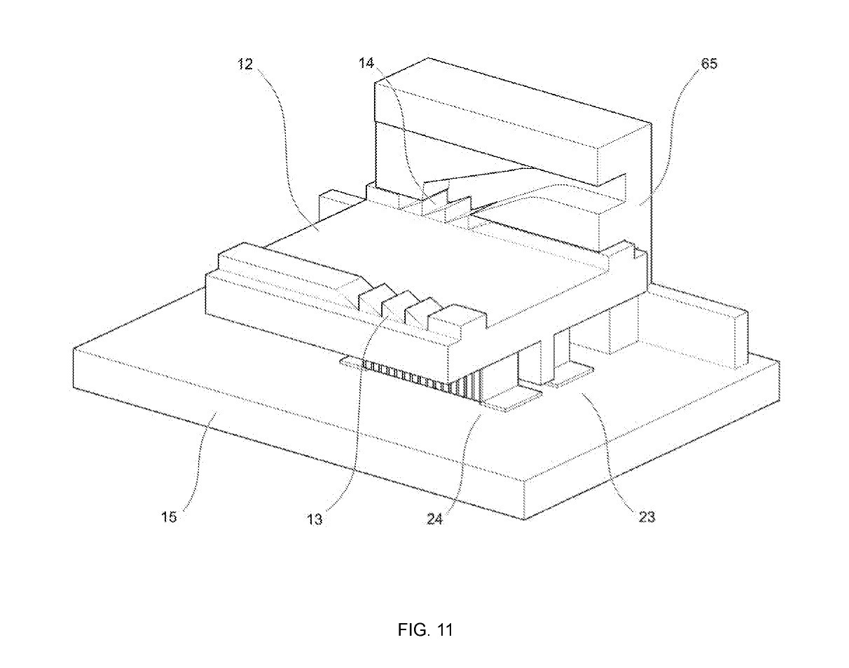

In FIG. 11, a movable bi-directional folded rack (12) is shown attached to the movable contactor (11). The movable contactor (11) is hidden in this view. The movable bi-directional folded rack (12) positions the movable contactor (11). The movable bi-directional folded rack (12) is supported by a rear package side rail (65) which is supported by a firm component package base (15). The movable bi-directional folded rack (12) is also supported by a firm front side rail which for better clarity is not shown in this view. The front side rail (66) is shown in FIG. 6. It is identical to the rear side rail (65) but is installed rotated 180 degrees about a vertical axis.

The movable bi-directional folded rack (12) is positioned by opposing rack teeth (13) and (14) which permit either increasing or decreasing in single steps the capacitance which appears at the capacitor terminals (31) and (32) in FIG. 10. FIG. 11 is analogous to FIG. 3 and shows that to the extent feasible and as intended, the linear capacitor exemplar embodiment makes use of structures which are identical to those of the linear inductor exemplar embodiment. The remainder of the linear capacitor exemplar construction is as depicted in FIGS. 4, 5, 6, 7 and 8 and is as described in their discussion.

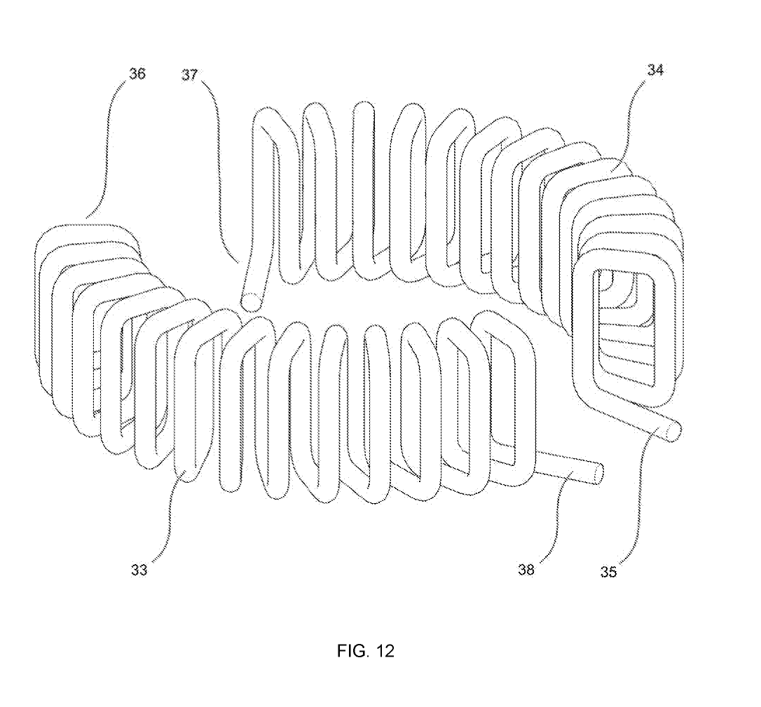

Exemplar partial-toroid inductor details The partial-toroid inductor exemplar embodiment is shown in FIGS. 12 through 16. FIG. 12 shows a partial-toroid coil pair (33) and (34). Far coil (34) has near end (35) and far end (37). Near coil (33) has near end (38) and far end (36). Far end (36) is hidden in this view. The partial-toroid coil pair (33) and (34) is wound on an insulating toroid core. For clarity the insulating toroid core is not shown in this view. The partial-toroid coil pair (33) and (34) is shown configured to share magnetic flux. Flux sharing is obtained by arrangement of the partial-toroid coil pair (33) and (34) for continuous current parity about a closed magnetic-field path (35) to (37) to (36) to (38) closed to (35).

Taking current parity to be right-handed at the far coil near end (35), magnetic field direction can be taken into far coil (34) from near end (35) toward far end (37). A rotatable contactor between the two coils will cause continuous current to leave coil (34), go into the contactor and to enter coil (33) from the contactor. This causes continuous current to have left-handed parity from the contactor to the far end (36) of the near coil (33) so that the required continuation of the magnetic field from coil (34) enters the far end (36) of coil (33) and from there to re-entry into coil (34) at near end (35).

Use of flux-sharing in the partial-toroid coil pair (33) and (34) realizes a coil structure that is more compact than that of a coil without a closed magnetic-field path for production of a given inductance. This results in smaller overall component size. Also, as is the case for a conventional toroid coil, flux-sharing gives better isolation of the inductor from external signals, which are effectively interfering noise. This achieves better effective noise performance.

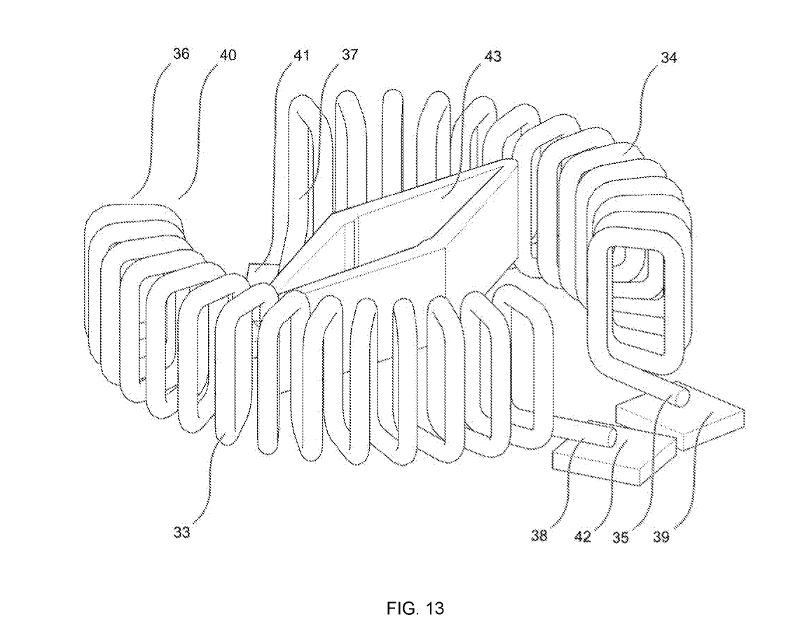

In FIG. 13 the partial toroid coil pair (33) and (34) is shown supported by mounting pads (39), (40), (41) and (42) for compatibility with a component package as required. Mounting pad (40) is hidden in this view. The partial-toroid coil pair (33) and (34) is wound on an insulating toroid core. For clarity the insulating toroid core is not shown in this view. Mounting pads (39) and (40) function as the inductor terminals (39) and (40). Mounting pads (41) and (42) provide electrically-isolated mechanical support. Depending upon detailed considerations, mounting pads (41) and (42) may be omitted. A rotatable contactor (43) which provides electrical connection between the partial-toroid coils (33) and (34) is also shown. As the position of the rotatable contactor (43) is changed, the inductance which appears at the inductor terminals (39) and (40) changes in steps over the required inductance range.

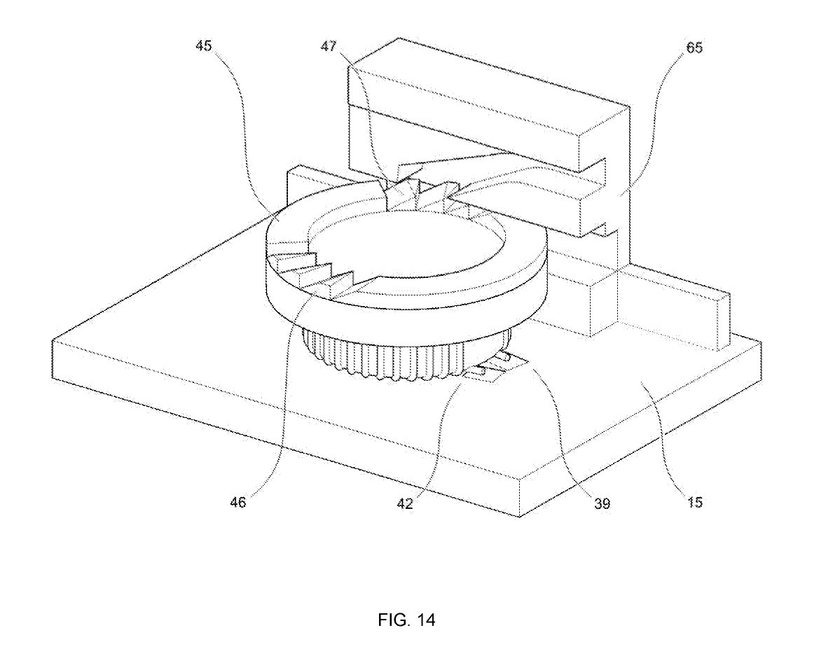

In FIG. 14, a rotatable bi-directional folded rack (45) is shown attached to the rotatable contactor (43). The rotatable contactor (43) is hidden in this view. The rotatable bi-directional folded rack (45) positions the rotatable contactor (43). The rotatable bi-directional folded rack (45) is supported by a firm rear package side rail (65) which is supported by a firm component package base (15). The rotatable bi-directional folded rack (45) is also supported by a firm front side rail which for better clarity is not shown in this view. The front side rail is now a mirror image of the front side rail (66) shown in FIG. 6. It is also a mirror image of the rear side rail (65). The rotatable bi-directional folded rack (45) is positioned by opposing rack teeth (46) and (47) which permit either increasing or decreasing in single steps the inductance which appears at the inductor terminals (39) and (40). Terminal (40) is hidden in this view.

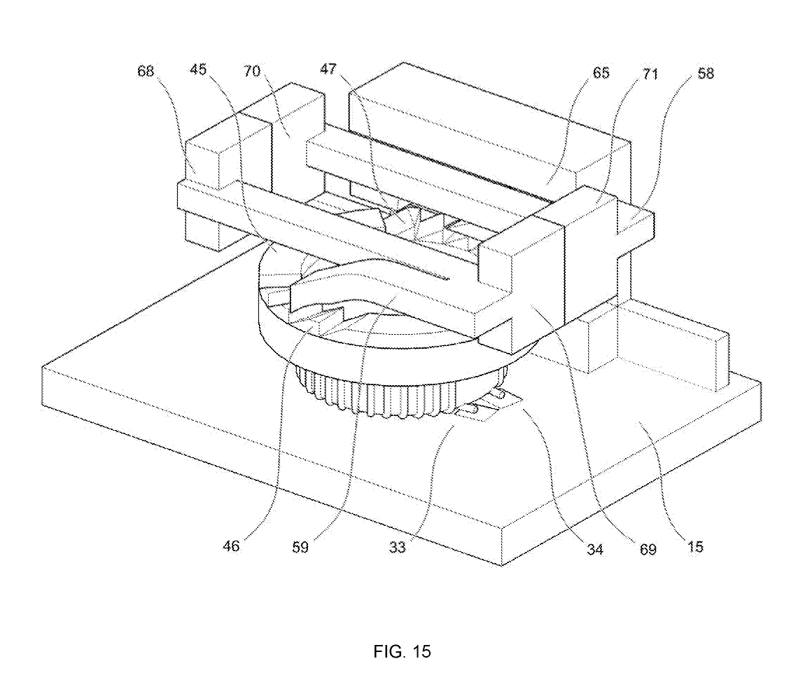

In FIG. 15 the partial toroid coil pair (33) and (34) and the rotatable bi-directional folded rack (45) are shown in place beneath a pair of movable single-stepping folded pawls (58) and (59). The rear pawl (58) is partly hidden in this view. The movable single-stepping folded pawls (58) and (59) face in the same direction. They throw alternately in the same direction rather than alternately in opposite directions. The pawls (58) and (59) are stiff but have some flexibility in the vertical direction. This allows the pawls (58) and (59) to engage the rack teeth (46) and (47) and to move the rotatable bi-directional folded rack (45) one tooth length at a time. A pair of actuator frames (68) to (69) and (70) to (71) is nested within the movable single-stepping folded pawls (59) and (58). Each actuator frame (68) to (69) and (70) to (71) is attached to its respective pawl (59) and (58).

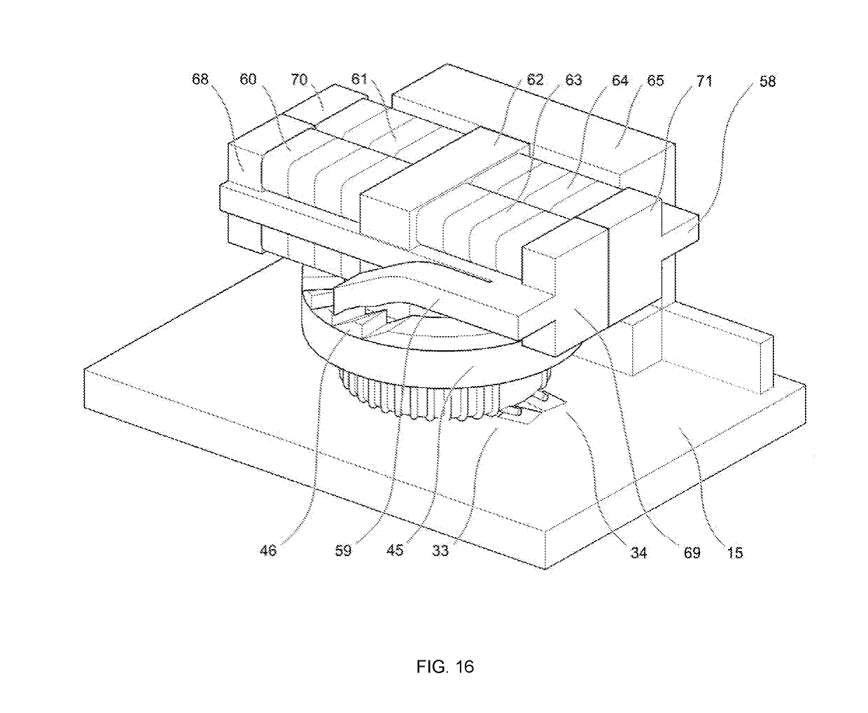

In FIG. 16 two bi-directional actuators (60) to (63) and (61) to (64) are shown nested within the movable single-stepping folded pawls (58) and (59) and the actuator frames (68) to (69) and (70) to (71). The nested bi-directional actuators (60) to (63) and (61) to (64) permit remotely-controllable positioning of the movable single-stepping folded pawls (58) and (59).

The actuators (60) to (63) and (61) to (64) have a firm center block (62). The center block (62) does not move and provides support for the expandable and contractible actuators (60) to (63) and (61) to (64). For better clarity, connection of control lines to the actuators is not shown. The actuator block (62) is firmly supported by the rear side rail (65) and the front side rail. For clarity, the front side rail is not shown in this view. The front side rail is a mirror image of the rear side rail (65).

FIG. 16 shows that to the extent feasible and as intended, the partial-toroid inductor exemplar embodiment makes use of the same structures as the linear inductor exemplar embodiment. The remainder of the partial-toroid inductor exemplar construction is as depicted in FIGS. 6, 7 and 8 and is as described in their discussion.

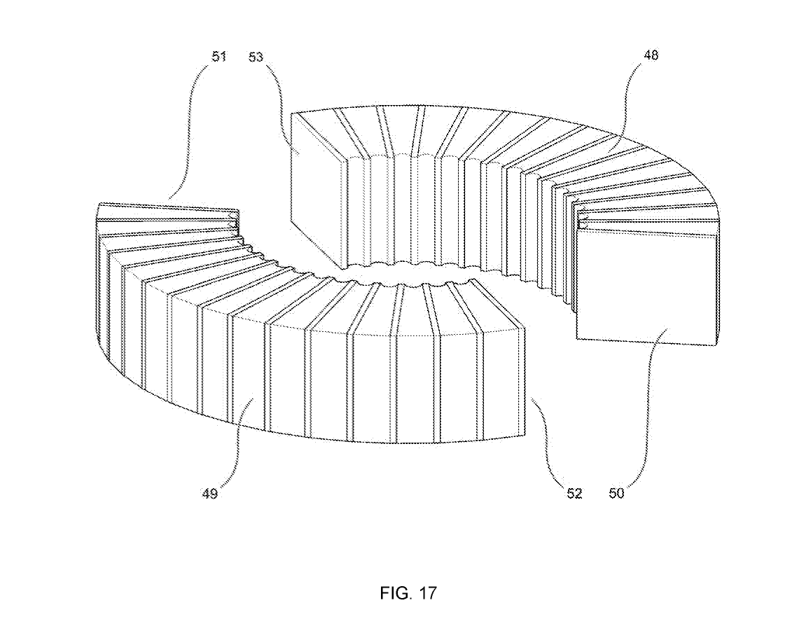

Exemplar partially-circular capacitor details The partially-circular capacitor exemplar embodiment is shown in FIGS. 17, 18 and 19. FIG. 17 shows a partially-circular capacitor stack pair (48) and (49). The far stack (48) has near end (50) and far end (53). The near stack (49) has near end (52) and far end (51).

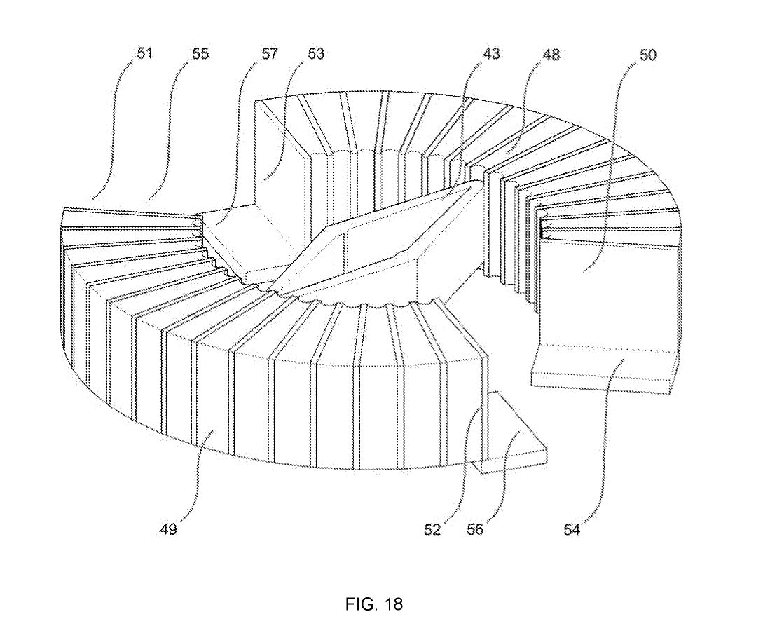

In FIG. 18 the partially-circular capacitor stack pair (48) and (49) is shown supported by mounting pads (54), (55), (56) and (57) for compatibility with a component package as required. Mounting pad (55) is hidden in this view. Mounting pads (54) and (55) function as the capacitor terminals (54) and (55). Mounting pads (56) and (57) provide electrically-isolated mechanical support. Depending upon detailed considerations, mounting pads (56) and (57) may be omitted. A rotatable contactor (43) which provides electrical connection between the arms of the partially-circular capacitor stack pair (48) and (49) is also shown. As the position of the rotatable contactor (43) is changed, the capacitance which appears at the capacitor terminals (54) and (55) changes in steps over the required capacitance range.

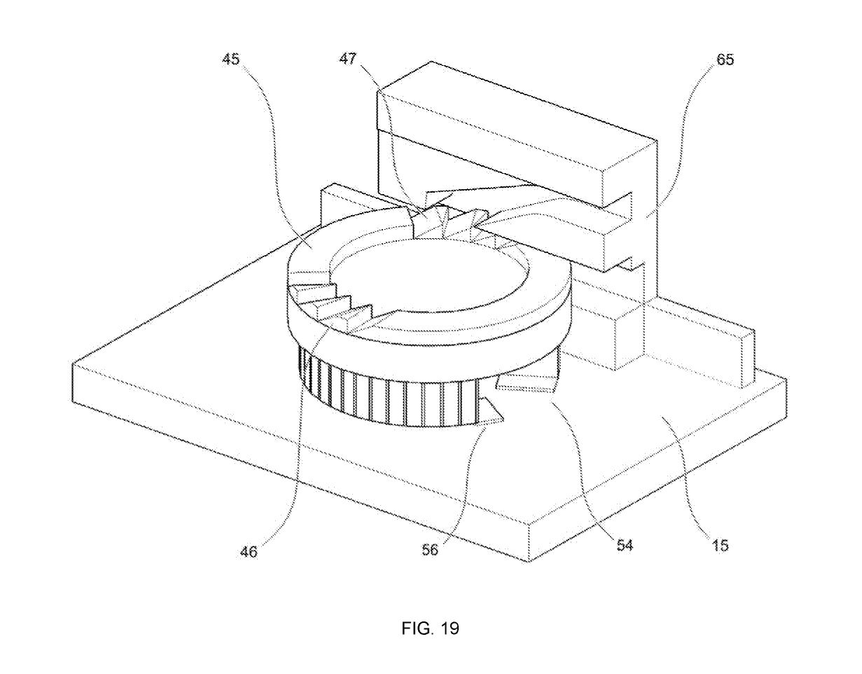

In FIG. 19 a rotatable bi-directional folded rack (45) is shown attached to the rotatable contactor (43). The rotatable contactor (43) is hidden in this view. The rotatable bi-directional folded rack (45) positions the rotatable contactor (43). The rotatable bi-directional folded rack (45) s supported by a firm rear package side rail (65) which is supported by a firm component package base (15). The rotatable bi-directional folded rack (45) is also supported by a firm front side rail. For clarity, the front side rail is not shown in this view. The front side rail is a mirror image of the rear side rail (65). The rotatable bi-directional folded rack (45) is positioned by opposing rack teeth (46) and (47) which permit either increasing or decreasing in single steps the capacitance which appears at the capacitor terminals (54) and (55).

FIG. 19 is analogous to FIG. 14 and shows that to the extent feasible and as intended, the partially-circular capacitor exemplar embodiment makes use of structures which are identical to those of the partial-toroid inductor exemplar embodiment. The remainder of the partially-circular capacitor exemplar construction is as depicted in FIGS. 15, 16, 6, 7 and 8 and is as described in their discussion.

1. What is claimed is a miniature remotely-controllable variable impedance structure having many embodiments, different embodiments being realized by adjusting the forms and materials of:
a firm and supporting component base or package base with electrically isolated and electrically conductive terminals, which base includes or accepts firm and firmly attached or firmly attachable side rails and which base accepts a firm and firmly attachable cover, which cover includes or accepts a firm or firmly attachable lid, and which package provides firm support for a nested rack-and-pawl mechanism and for a nested actuator mechanism;
firm parallel solenoid-coil cores which support parallel conductive solenoid coils, which coils are arranged to share magnetic flux in a closed path, which cores and coils are firmly attached to the package base, one end of each coil being firmly and electrically connected to a separate package base terminal, the remaining end of each coil having no electrical connection but being firmly attached to the package base, which coils are shorted by a movable contactor mechanism, which coils are arranged for stepped electrical connection with the movable contactor mechanism or which coils have contacts which are arranged along the coils to have stepped electrical connection with the movable contactor mechanism, the length, the diameter and the spacing or pitch of the coils or pitch of the coil contacts being arranged to realize a required minimum withstanding voltage and to realize a required minimum to maximum inductance at a required frequency in a required number of steps when the coils are shorted by the movable contactor mechanism in stepped positions;
a conductive bi-directional linearly-movable contactor mechanism which shorts the parallel solenoid coils as the contactor mechanism is moved by a ratchet mechanism, which contactor mechanism is composed of material having elasticity or which contactor mechanism incorporates sprung rollers for electrical contact with the parallel solenoid coils and which contactor mechanism operates so that as the contactor mechanism is moved closer to or farther away from the coil terminals, the inductance which appears between the package base terminals correspondingly decreases or increases;
a folded and nested bi-directional single-stepping rack-and-pawl ratchet mechanism, the tooth size or step pitch of which ratchet mechanism is matched to the winding pitch or step pitch of the solenoid coils or solenoid coil contacts;
and a remotely-controllable bi-directional actuator mechanism, which actuator mechanism is nested within the ratchet mechanism, the displacement length of which actuator mechanism is matched to the tooth size or step pitch of the ratchet mechanism and to the winding pitch or step pitch of the solenoid coils or solenoid coil contacts;
where the exemplar embodiment of the claimed miniature remotely-controllable variable impedance structure is a miniature remotely-controllable single-stepping low-noise variable inductor, which is realized by adjusting the forms and materials of said component package, of said parallel solenoid coils, of said contactor mechanism, of said ratchet mechanism and of said actuator mechanism;
and where the said exemplar embodiment is realized by fabrication of all parts from materials which contain no ferromagnetic or other substance producing a spurious magnetic-resonance response detectable by test in a medical magnetic-resonance imaging system;
and where all parts of the said exemplar package base, all parts of the said exemplar solenoid cores, all parts of the said exemplar ratchet mechanism and all parts of the said exemplar actuator mechanism are fabricated from insulating materials to the extent feasible;
and where the said exemplar embodiment is realized by fabrication of insulating parts from material or materials which are transparent to the electromagnetic field to the extent feasible;
and where the said exemplar embodiment is realized by fabrication of conductive parts from materials having the highest feasible electrical conductivity;
and where the said exemplar embodiment is realized by means of a single movable contactor and a single pair of parallel solenoid coils;
and where the said exemplar embodiment is realized by adjustment of the sizes, shapes and interaction of the parts so that the exemplar embodiment occupies a volume of no more than 30 cubic centimeters;
and where all parts of the said package base, all parts of the said solenoid cores and coils, all parts of the said contactor mechanism, all parts of the said ratchet mechanism and all parts of the said actuator mechanism are fabricated from materials which are compatible with automated printed-circuit-board installation;
whereby the said exemplar embodiment of the claimed miniature remotely-controllable variable impedance structure is realized as a remotely-controllable single-stepping low-noise variable inductor, which inductor is compatible with medical magnetic-resonance imaging requirements, which inductor is compatible with automated printed-circuit-board installation, which inductor has a noise figure of no more than 0.2 decibel, which inductor operates at 128 megahertz, which inductor can withstand 500 volts without faulting and which inductor provides at its two terminals minimum to maximum inductance variable from 30 nanohenry to 80 nanohenry plus or minus 2 percent in 5 steps.

2. What is claimed is a miniature remotely-controllable variable impedance structure having many embodiments, different embodiments being realized by adjusting the forms and materials of:
a firm and supporting component base or package base with electrically isolated and electrically conductive terminals, which base includes or accepts firm and firmly attached or firmly attachable side rails and which base accepts a firm and firmly attachable cover, which cover includes or accepts a firm or firmly attachable lid, and which package provides firm support for a nested rack-and-pawl mechanism and for a nested actuator mechanism;
a firm or firm toroid-coil core or cores which supports or support toroid or partial-toroid coils, which toroid or partial-toroid coils are arranged to share magnetic flux in a closed path, which cores and coils are firmly attached to the package base, one end of each coil being firmly and electrically connected to a separate package base terminal, the remaining end of each coil having no electrical connection but being firmly attached to the package base, which coils are shorted by a rotatable contactor mechanism, which coils are arranged for stepped electrical connection with the rotatable contactor mechanism or which coils have contacts which are arranged along the coils to have stepped electrical connection with the rotatable contactor mechanism, the length, the diameter and the spacing or pitch of the coils or pitch of the coil contacts being arranged to realize a required minimum withstanding voltage and to realize a required minimum to maximum inductance at a required frequency in a required number of steps when the coils are shorted by the rotatable contactor mechanism in stepped positions;
a conductive bi-directional rotatable contactor mechanism which shorts the toroid or partial-toroid coils as the contactor mechanism is rotated by a ratchet mechanism, which contactor mechanism is composed of material having elasticity or which contactor mechanism incorporates sprung rollers for electrical contact with the toroid or partial-toroid coils and which contactor mechanism operates so that as the contactor mechanism is moved closer to or farther away from the coil terminals, the inductance which appears between the package base terminals correspondingly decreases or increases;
a folded and nested bi-directional single-stepping rack-and-pawl ratchet mechanism, the tooth size or step pitch of which ratchet mechanism is matched to the winding pitch or step pitch of the toroid or partial-toroid coils or coil contacts;
and a remotely-controllable bi-directional actuator mechanism, which actuator mechanism is nested within the ratchet mechanism, the displacement length of which actuator mechanism is matched to the tooth size or step pitch of the ratchet mechanism and to the winding pitch or step pitch of the toroid or partial-toroid coils or coil contacts;
where the exemplar embodiment of the claimed miniature remotely-controllable variable impedance structure is a miniature remotely-controllable single-stepping low-noise variable inductor, which is realized by adjusting the forms and materials of said component package, of said toroid or partial-toroid coils, of said contactor mechanism, of said ratchet mechanism and of said actuator mechanism;
and where the said exemplar embodiment is realized by fabrication of all parts from materials which contain no ferromagnetic or other substance producing a spurious magnetic-resonance response detectable by test in a medical magnetic-resonance imaging system;
and where all parts of the said exemplar package base, all parts of the said exemplar toroid cores, all parts of the said exemplar ratchet mechanism and all parts of the said exemplar actuator mechanism are fabricated from insulating materials to the extent feasible;
and where the said exemplar embodiment is realized by fabrication of insulating parts from material or materials which are transparent to the electromagnetic field to the extent feasible;
and where the said exemplar embodiment is realized by fabrication of conductive parts from materials having the highest feasible electrical conductivity;
and where the said exemplar embodiment is realized by means of a single rotatable contactor and a single pair of partial-toroid coils;
and where the said exemplar embodiment is realized by adjustment of the sizes, shapes and interaction of the parts so that the exemplar embodiment occupies a volume of no more than 30 cubic centimeters;
and where all parts of the said package base, all parts of the said toroid core and partial-toroid coils, all parts of the said contactor mechanism, all parts of the said ratchet mechanism and all parts of the said actuator mechanism are fabricated from materials which are compatible with automated printed-circuit-board installation;
whereby the said exemplar embodiment of the claimed miniature remotely-controllable variable impedance structure is realized as a remotely-controllable single-stepping low-noise variable inductor, which inductor is compatible with medical magnetic-resonance imaging requirements, which inductor is compatible with automated printed-circuit-board installation, which inductor has a noise figure of no more than 0.2 decibel, which inductor operates at 128 megahertz, which inductor can withstand 500 volts without faulting and which inductor provides at its two terminals minimum to maximum inductance variable from 30 nanohenry to 80 nanohenry plus or minus 2 percent in 5 steps.

3. What is claimed is a miniature remotely-controllable variable impedance structure having many embodiments, different embodiments being realized by adjusting the forms and materials of:
a firm and supporting component base or package base with electrically isolated and electrically conductive terminals, which base includes or accepts firm and firmly attached or firmly attachable side rails and which base accepts a firm and firmly attachable cover, which cover includes or accepts a firm or firmly attachable lid, and which package provides firm support for a nested rack-and-pawl mechanism and for a nested actuator mechanism;
parallel linear stacks of capacitors, the capacitors of each stack being firmly attached together by conductive material, which capacitor stacks are firmly attached to the package base, one end of each capacitor stack being firmly and electrically connected to a separate package base terminal, the remaining end of each capacitor stack having no electrical connection but being firmly attached to the package base, which capacitor stacks are shorted by a movable contactor mechanism, which parallel linear capacitor stacks have contacts which are arranged along the stack capacitors to have stepped electrical connection with the movable contactor mechanism, the length, the cross-section area, the materials of the capacitors and the spacing or pitch of the capacitor contacts being arranged to realize a required minimum withstanding voltage and to realize a required minimum to maximum capacitance at a required frequency in a required number of steps when the capacitor stacks are shorted by the movable contactor mechanism in stepped positions;
a conductive bi-directional linearly-movable contactor mechanism which shorts the parallel linear capacitor stacks as the contactor mechanism is moved by a ratchet mechanism, which contactor mechanism is composed of material having elasticity or which contactor mechanism incorporates sprung rollers for electrical contact with the parallel linear capacitor stacks and which contactor mechanism operates so that as the contactor mechanism is moved closer to or farther away from the parallel linear capacitor stack terminals, the capacitance which appears between the package base terminals correspondingly increases or decreases;
a folded and nested bi-directional single-stepping rack-and-pawl ratchet mechanism, the tooth size or step pitch of which ratchet mechanism is matched to the step pitch of the parallel linear capacitor stack contacts;
and a remotely-controllable bi-directional actuator mechanism, which actuator mechanism is nested within the ratchet mechanism, the displacement length of which actuator mechanism is matched to the tooth size or step pitch of the ratchet mechanism and to the step pitch of the parallel linear capacitor stack contacts;
where the exemplar embodiment of the claimed miniature remotely-controllable variable impedance structure is a miniature remotely-controllable single-stepping low-noise variable capacitor, which is realized by adjusting the forms and materials of said component package, of said parallel linear capacitor stacks, of said contactor mechanism, of said ratchet mechanism and of said actuator mechanism;
and where the said exemplar embodiment is realized by fabrication of all parts from materials which contain no ferromagnetic or other substance producing a spurious magnetic-resonance response detectable by test in a medical magnetic-resonance imaging system;
and where all parts of the said exemplar package base, all parts of the said exemplar parallel linear capacitor stacks, all parts of the said exemplar ratchet mechanism and all parts of the said exemplar actuator mechanism are fabricated from insulating materials to the extent feasible;
and where the said exemplar embodiment is realized by fabrication of insulating parts from material or materials which are transparent to the electromagnetic field to the extent feasible;
and where the said exemplar embodiment is realized by fabrication of conductive parts from materials having the highest feasible electrical conductivity;
and where the said exemplar embodiment is realized by means of a single movable contactor and a single pair of parallel linear capacitor stacks, which capacitor stacks are composed of capacitors having the lowest feasible loss;
and where the said exemplar embodiment is realized by adjustment of the sizes, shapes and interaction of the parts so that the exemplar embodiment occupies a volume of no more than 30 cubic centimeters;
and where all parts of the said package base, all parts of the said parallel linear capacitor stacks, all parts of the said contactor mechanism, all parts of the said ratchet mechanism and all parts of the said actuator mechanism are fabricated from materials which are compatible with automated printed-circuit-board installation;
whereby the said exemplar embodiment of the claimed miniature remotely-controllable variable impedance structure is realized as a remotely-controllable single-stepping low-noise variable parallel-linear-stack capacitor, which capacitor is compatible with medical magnetic-resonance imaging requirements, which capacitor is compatible with automated printed-circuit-board installation, which capacitor has a noise figure of no more than 0.2 decibel, which capacitor operates at 128 megahertz, which capacitor can withstand 500 volts without faulting and which capacitor provides at its two terminals minimum to maximum capacitance variable from 15 picofarad to 140 picofarad plus or minus 2 percent in 5 steps.

4. What is claimed is a miniature remotely-controllable variable impedance structure having many embodiments, different embodiments being realized by adjusting the forms and materials of:
a firm and supporting component base or package base with electrically isolated and electrically conductive terminals, which base includes or accepts firm and firmly attached or firmly attachable side rails and which base accepts a firm and firmly attachable cover, which cover includes or accepts a firm or firmly attachable lid, and which package provides firm support for a nested rack-and-pawl mechanism and for a nested actuator mechanism;
circular or partially-circular stacks of capacitors, the capacitors of each stack being firmly attached together by conductive material, which capacitor stacks are firmly attached to the package base, one end of each capacitor stack being firmly and electrically connected to a separate package base terminal, the remaining end of each capacitor stack having no electrical connection but being firmly attached to the package base, which capacitor stacks are shorted by a rotatable contactor mechanism, which circular or partially-circular capacitor stacks have contacts which are arranged along the stack capacitors to have stepped electrical connection with the movable contactor mechanism, the length, the cross-section area, the materials of the capacitors and the spacing or pitch of the capacitor contacts being arranged to realize a required minimum withstanding voltage and to realize a required minimum to maximum capacitance at a required frequency in a required number of steps when the capacitor stacks are shorted by the rotatable contactor mechanism in stepped positions;
a conductive bi-directional rotatable contactor mechanism which shorts the circular or partially-circular capacitor stacks as the contactor mechanism is rotated by a ratchet mechanism, which contactor mechanism is composed of material having elasticity or which contactor mechanism incorporates sprung rollers for electrical contact with the circular or partially-circular capacitor stacks and which contactor mechanism operates so that as the contactor mechanism is rotated closer to or farther away from the circular or partially-circular capacitor stack terminals, the capacitance which appears between the package base terminals correspondingly increases or decreases;
a folded and nested bi-directional single-stepping rack-and-pawl ratchet mechanism, the tooth size or step pitch of which ratchet mechanism is matched to the step pitch of the circular or partially-circular capacitor stack contacts;
and a remotely-controllable bi-directional actuator mechanism, which actuator mechanism is nested within the ratchet mechanism, the displacement length of which actuator mechanism is matched to the tooth size or step pitch of the ratchet mechanism and to the step pitch of the circular or partially-circular capacitor stack contacts;
where the exemplar embodiment of the claimed miniature remotely-controllable variable impedance structure is a miniature remotely-controllable single-stepping low-noise variable capacitor, which is realized by adjusting the forms and materials of said component package, of said circular or partially-circular capacitor stacks, of said contactor mechanism, of said ratchet mechanism and of said actuator mechanism;
and where the said exemplar embodiment is realized by fabrication of all parts from materials which contain no ferromagnetic or other substance producing a spurious magnetic-resonance response detectable by test in a medical magnetic-resonance imaging system;
and where all parts of the said exemplar package base, all parts of the said exemplar circular or partially-circular capacitor stacks, all parts of the said exemplar ratchet mechanism and all parts of the said exemplar actuator mechanism are fabricated from insulating materials to the extent feasible;
and where the said exemplar embodiment is realized by fabrication of insulating parts from material or materials which are transparent to the electromagnetic field to the extent feasible;
and where the said exemplar embodiment is realized by fabrication of conductive parts from materials having the highest feasible electrical conductivity;
and where the said exemplar embodiment is realized by means of a single rotatable contactor and a single pair of partially-circular capacitor stacks, which capacitor stacks are composed of capacitors having the lowest feasible loss;
and where the said exemplar embodiment is realized by adjustment of the sizes, shapes and interaction of the parts so that the exemplar embodiment occupies a volume of no more than 30 cubic centimeters;
and where all parts of the said package base, all parts of the said partially-circular capacitor stacks, all parts of the said contactor mechanism, all parts of the said ratchet mechanism and all parts of the said actuator mechanism are fabricated from materials which are compatible with automated printed-circuit-board installation;
whereby the said exemplar embodiment of the claimed miniature remotely-controllable variable impedance structure is realized as a remotely-controllable single-stepping low-noise variable partially-circular-stack capacitor, which capacitor is compatible with medical magnetic-resonance imaging requirements, which capacitor is compatible with automated printed-circuit-board installation, which capacitor has a noise figure of no more than 0.2 decibel, which capacitor operates at 128 megahertz, which capacitor can withstand 500 volts without faulting and which capacitor provides at its two terminals minimum to maximum capacitance variable from 15 picofarad to 140 picofarad plus or minus 2 percent in 5 steps.
